(19) United States
(12) Patent Application Publication
(10) Pub. No.: US 2009/0119720 A1
(43) Pub. Date: May 7, 2009

(54) Rear Seat Entertainment System

(75) Inventors: Eric S Deuel, Allendale, MI (US); Peter W. Mokris, Holland, MI (US); Steve Schultz, Holland, MI (US); Lance E. Tinder, Hudsonville, MI (US); Douglas W. Klamer, Holland, MI (US); Loren D. Vredevoogd, Holland, MI (US); David Straight, Caledonia, MI (US)

Correspondence Address: FOLEY AND LARDNER LLP;SUITE 500, 3000 K STREET NW, WASHINGTON, DC, 20007, US

(73) Assignee: Johnson Controls Technology Company

(21) Appl. No.: 11/991,549

(22) PCT Filed: Sep. 7, 2006
(86) PCT No.: PCT/US06/34884

§ 371 Date: Jan. 15, 2009

Related U.S. Application Data
(60) Provisional application No. 60/715,033, filed on Sep. 8, 2005.
(60) Provisional application No. 60/840,183, filed on Aug. 25, 2006.

(51) Int. Cl. H04N 7/18; G06K 9/18; H04N 5/44; G10L 21/00

(52) U.S. Cl. 725/75; 382/182; 348/734; 704/275; 704/E21.001; 348/E05.096

(57) ABSTRACT

The present rear seat entertainment system provides a second display and interface in the front section of a motor vehicle for control of a media player with a rear mounted first display. The second display shows still video images (or screen shots) from the media player for real time updates on the status of the first display in the rear section of the vehicle according to adjustments made by the second user interface. The entertainment system includes a portable controller with the second display incorporated therein.

### CROSS-REFERENCE TO RELATED APPLICATIONS

This application is related to U.S. Provisional Application No. 60/715,033, entitled, “Interface for Vehicle Entertainment System,” and U.S. Provisional Application No. 60/840,183, entitled “Rear Seat Entertainment System,” which are herein incorporated by reference in their entirety.

### BACKGROUND

The present invention relates to a vehicle entertainment system and in particular, to a driver or front interface for a vehicle entertainment system.

Many vehicles include an in-vehicle entertainment system for use by vehicle passengers. A vehicle entertainment system may include one or more electronic components such as a video display, radio, CD player, video cassette player, DVD player, video game controller and computers. In addition, a vehicle entertainment system may include, for example, speakers or headphones to provide audio content to passengers in the vehicle. While traveling, passengers may use the vehicle entertainment system to, for example, watch television, recorded videos or other programming, listen to, music or play video games.

The video display of a rear seat entertainment system is mounted in the vehicle so that it is visible to passengers in the rear portion of the vehicle (e.g., not the driver and passengers in the front seats of the vehicle). In addition, the user interfaces for video content viewed on the rear seat entertainment system are typically only accessible by rear seat passengers. Many digital forms of media (e.g., a digital versatile video disc (DVD)) include default menus that are graphically displayed when, for example, a “PLAY” command is first provided to a media drive used to read the media. Typically, the media player displays the default menu from the digital media and waits for user input (e.g., selection of a menu item). The information provided in the digital media menu, such as menu items and selection arrows indicating the menu selection currently highlighted is visible to rear seat passengers; however, is not visible to the driver or a front seat passenger. This can present a problem when a driver or front seat passenger wishes or needs to be aware of the status of the media drive, for example, a driver with young children as passengers in the rear seats of the vehicle.

Contemporary media players relay frames at a rate of at least 24 frames per second to effectuate a motion picture effect. Providing a display for showing motion pictures in the front section of a vehicle at 24 frames per second (or greater) may not be an option given government regulations prohibiting television monitors or motion pictures from being viewable by the vehicle driver while operating the vehicle.

Thus, there is a need for a rear seat entertainment system including a driver or front interface located in a front section of the vehicle that provides a driver or front seat passenger access to menu content, graphical still images of the current screen view, and/or status information for media being played on a media drive of the rear seat entertainment system.

### SUMMARY

One embodiment of the invention relates to a vehicle entertainment system including a media player configured to read data from a medium. The data includes video signals. A first display is configured to display the video signals to a rear section of the vehicle. A first control circuit is coupled to the media player and includes a decoder module configured to decode data received from the media player and to transmit at least one of media player mode data, menu information or video signals to the first display. A second display is configured to display the video signals to a front section of the vehicle. A second control circuit is coupled to the second display and configured to receive and transmit at least one of media player mode data, menu information or screen shots of the video signals to the second display.

In another exemplary embodiment, a vehicle entertainment system includes a media player configured to read data from a medium. The data includes video signals. A first display is configured to display the video signals to a rear section of the vehicle. A first control circuit is coupled to the media player comprising a decoder module configured to decode data received from the media player and to transmit at least one of media player mode data, menu information or video signals to the first display. A second display is configured to display the video signals to a front section of the vehicle. A second control circuit is coupled to the second display and configured to receive and transmit at least one of media player mode data, menu information or screen shots of the video signals to the second display. A user input device is coupled to the second control circuit. The user input device is a microphone and the second control circuit includes voice recognition software, configured to send a control signal to the media player to control the media player mode of operation.

In yet another exemplary embodiment, a method for providing a front seat passenger of a vehicle with an interface to a rear seat entertainment system. The method includes: providing at least one of video signals, menu information or media player mode data to a first display viewable in a rear section of the vehicle; transmitting the at least one of screen shot data, menu information and media player mode data to a portable electronic device locatable in the front section of the vehicle. The transmitting step is performed wireless. The method also includes receiving the transmitted data at the portable electronic device.

### BRIEF DESCRIPTION OF THE DRAWINGS

FIG. 1 is a perspective view of a vehicle including a rear seat entertainment system in accordance with an exemplary embodiment.

FIG. 2 is an overhead view of a vehicle including the rear seat entertainment system of FIG. 1.

FIG. 3 is a front perspective of a vehicle entertainment system video display and media player in accordance with an exemplary embodiment.

FIG. 4 is a chart of a first and second row display for a rear seat entertainment system in accordance with an exemplary embodiment.

FIG. 5 is a side view of an exemplary user interface for a rear seat entertainment system in accordance with an exemplary embodiment.

FIG. 6 is a schematic block diagram of electronic components of a rear seat entertainment system including a driver or front interface in accordance with an exemplary embodiment.

FIG. 7 is a schematic block diagram of electronic components of a rear seat entertainment system including a driver or front interface in accordance with an exemplary embodiment

FIG. 8 is an exemplary graphical and textual menu display in accordance with an exemplary embodiment.

FIG. 9 is a schematic block diagram of electronic components of a rear seat entertainment system including a front interface in accordance with an exemplary embodiment.

### DETAILED DESCRIPTION

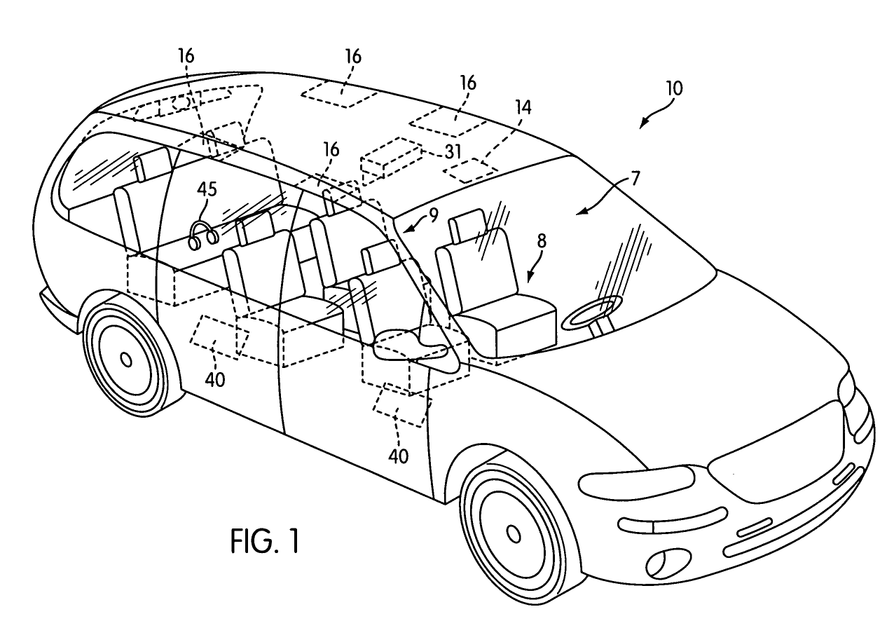

FIG. 1 is a perspective view of a vehicle including a rear seat entertainment system in accordance with an embodiment. A vehicle or automobile 10 includes a passenger compartment 7 divided into a forward or front passenger compartment or section 8 and a rear passenger compartment or section 9. The vehicle 10 may be, for example, a car, truck, sport utility vehicle, van, or mini-van. A driver of vehicle 10 sits in the front section 8 to control vehicle 10. A passenger may also sit in front section 8 in a seat next to the driver. Rear section 9 may include benches or seats for use by a plurality of passengers. In larger vehicles such as vans, mini-vans or sport-utility vehicles, two or more rows of seats may be included in rear section 9. Overhead lights 16 may also be provided to illuminate passenger compartment 7.

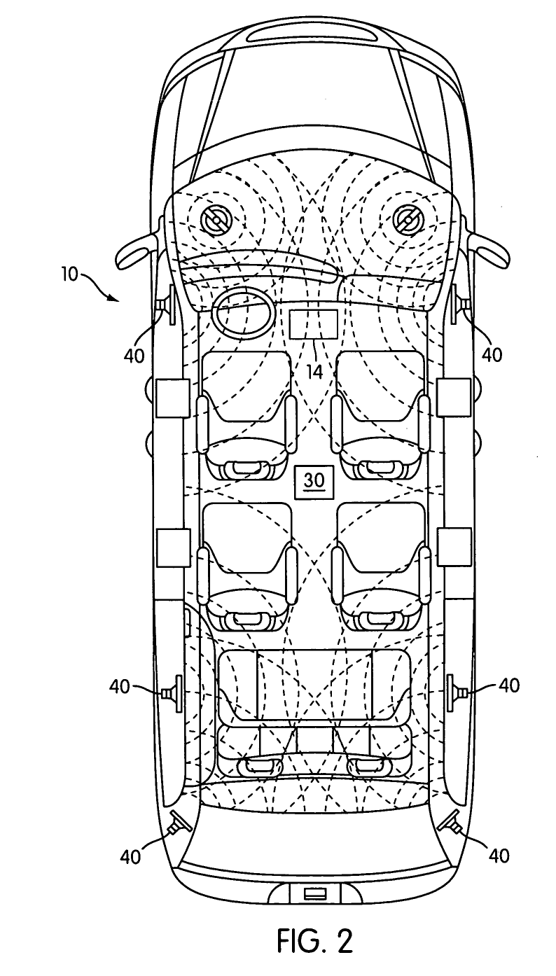

Vehicle 10 may also include a rear seat entertainment system 30 configured for providing entertainment to passengers in vehicle 10, as shown in FIG. 2. Entertainment system 30 may include one or more electronic components such as a video display 31 (shown in FIG. 1), a video cassette player, a digital versatile disc (DVD) player, a stereo system, a compact disc (CD) player, a computer, a video game console, an MP3 player, and any other entertainment component that may be adapted for use with vehicle entertainment systems. The various components may operate simultaneously to allow different passengers to enjoy different entertainment options at the same time.

Entertainment system 30 may be located in any suitable position in the interior of vehicle 10, or various components may be distributed throughout the interior of vehicle 10. For example, video display 31 (shown in FIG. 1) may be mounted to an interior roof or headliner of passenger compartment 7, while a media player, e.g., a DVD player, may be located in front section 8 or in rear passenger compartment 9. Additionally, more than one of each type of component may be included in entertainment system 30. For example, both the forward and rear passenger compartments may have separate stereo systems, so as to allow passengers in the front section 8 to listen to different audio broadcasts than those passengers in rear section 9.

At least one speaker 40 may be mounted within passenger compartment 7. As illustrated in FIGS. 1 and 2, a plurality of speakers 40 may be distributed throughout passenger compartment 7. All speakers 40 may broadcast identical audio signals or alternatively, speakers 40 located in front section 8 may be configured to broadcast different audio signals than speakers 40 located in rear section 9. Vehicle 10 may also be equipped with at least one pair of headphones 45 configured for receiving audio signals broadcast from rear seat entertainment system 30. Headphones 45 may be either wireless or wired headphones, and may have any of a number of configurations. For traditional wired headphones 45, output jacks or connectors may be located at various locations in vehicle 10 to allow passengers to conveniently connect headphones 45 to rear seat entertainment system 30.

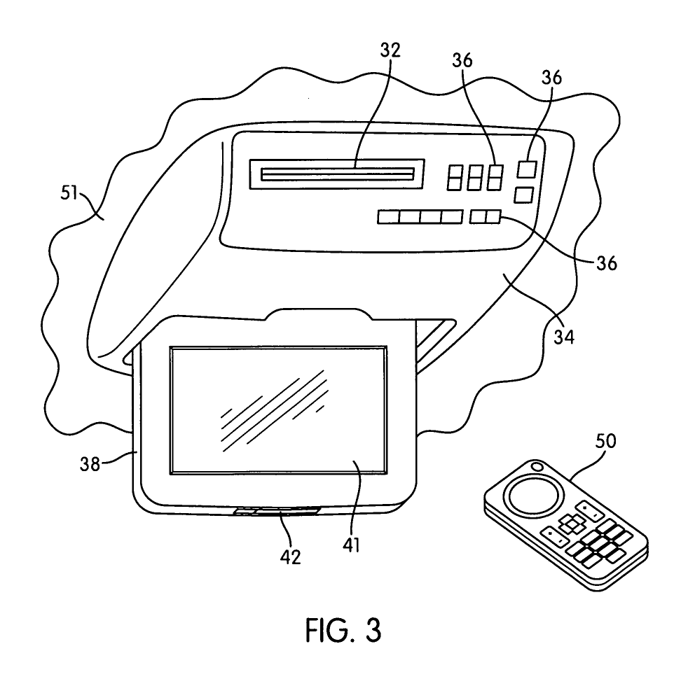

FIG. 3 is a front perspective of a rear seat entertainment system, comprising a video display and media player in accordance with an embodiment. The rear seat entertainment system 30 includes a media player (or drive) 32, such as a digital video disc (DVD) player 32 that is integrated in a housing 34. The housing 34 also includes a user input device having a plurality of controls or keys 36 that allow the user to operate the media player 32. Entertainment system 30 includes at least one video display 38, such as a video screen, LCD monitor, etc., to display data (e.g., video data, text data, etc.) to one or more occupants in a rear section of the vehicle. Video display 38 includes a screen portion 41 and may be rotatably mounted to the housing 34. In one embodiment, releasing a latch mechanism 42 allows the video display 38 to rotate from a first or closed position to a second or open position. A plurality of audio connectors (not shown) may also be integrated with the housing extending from the housing such that a user could connect speakers, headphones, or other conventionally known listening devices to the rear seat entertainment system 30. Although components of the rear seat entertainment system 30 are shown in FIGS. 1-3 as being mounted to a headliner 51 of a motor vehicle interior, it will be appreciated by one of ordinary skill in the art that one or more components of the rear seat entertainment system 30 could be mounted in or coupled to several areas of a vehicle, including, but not limited to, a seat back, a floor console, a center mounted console, etc. The rear seat entertainment system could also be incorporated into similar components within the cabin of a boat, aircraft, etc.

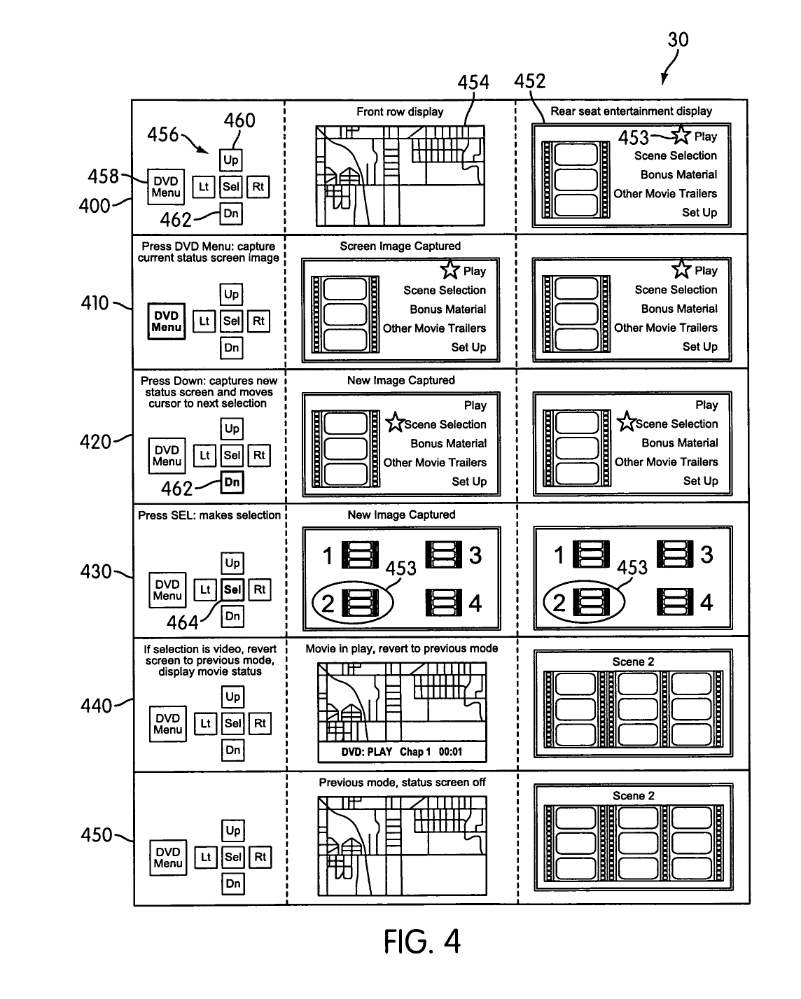

Rear seat entertainment system 30 may be operated using a number of different user input devices. FIG. 4 illustrates the function of a rear seat entertainment system 30 with at least two user input devices according to an embodiment. A first display 452 is included with the system 30. The first display 452 is coupled to a first control circuit to enable a rear seat passenger to control the media player. At step 400 the first display 452 shows menu information and mode data. Mode data includes the general operational settings for the media player including stop, play, rewind, fast forward and pause. Menu information includes the home screen or menu for digital media in which the user has the option to play various selections available on the media (e.g., “PLAY [for viewing the featured film from the opening scene]”, “SCENE SELECTION”, “BONUS MATERIAL”, “OTHER MOVIE TRAILERS”, “SET-UP”, etc.). An indicator 453 is provided on the menu screen to prompt the user for each selection. A second display 454 is included and coupled to a second control circuit located in the front section of the vehicle. When the media player is off or properly playing the subject film, the second display 454 may have information received from any vehicle system, e.g., vehicle system status, the GPS display as shown in the illustrated exemplary embodiment of FIG. 4 at step 400, etc. When it is desirable to control the media player, the second display 454 may display information pertinent to the rear seat entertainment system 30 as shown at step 410. The second user input device includes a key pad 456. The keypad has a plurality of switches (e.g., 458, 460, 462) for controlling the media player. In the illustrated embodiment, the second user input device includes a activation key 458 to selectively enable the second user input device to control the media player and other vehicle functions. In one exemplary embodiment, the second user input device only receives images from the media player when the activation key is selected and the input device is in media player mode. When not in media player mode, the second display 454 may show information regarding various vehicular functions including navigational information, fuel gauge, engine performance characteristics, etcetera.

To control the media player with the second user input device, the user may select an activation key 458 on the keypad 456, as illustrated at step 410. The second display 454 shows an image captured from the first display 452 and/or media player. The image is sent via video signals from the rear entertainment system. Each image is a screen shot or a reproduction of the current screen of a video display. A series of reproductions are transmitted to the second display 454 at a rate substantially less than motion picture speed. In one embodiment, the images are sent at a rate less than 24 frames per second to effectuate a still image or screen shot effect. By viewing the current screen on the first display 452, is knowledgeable as to the status of the media player. With the second user input device (or keypad 456) the user may instruct the media player to perform all of the functions the rear seat passengers may instruct the media player to perform, e.g., “PLAY”, “SCENE SELECTION”, “BONUS MATERIALS”, “OTHER MOVIE TRAILERS” and “SET UP”.

The user input device 456 enables the user to navigate the menu screen as shown at step 420. As illustrated, the user may select the down button 462 on the keypad to choose scene selections as opposed to playing the subject film from the beginning. This option may be more suitable for movies that have been at least partially previously viewed by the rear seat passengers. Accordingly, the on-screen indicator 453 moves to the “SCENE SELECTION” option on both displays 452 and 454. The user selects the “SCENE SELECTION” option by pressing the select key 464 on the keypad 456, as shown at step 430. On the first and second display 452, 454, a new image is captured. The new image displays a choice between movie scenes. The user may select the scene by pressing the select key 464 when the on-screen indicator 453 is on the appropriate selection. In the illustrated exemplary embodiment, the user has selected Scene No. 2. Once the media player plays the subject film the second display may revert to its previous mode (e.g., displaying GPS information as shown in FIG. 4 at steps 440 and 450).

In one exemplary embodiment, the second display 454 is only able to display images from the rear entertainment system 30 as screen shots as opposed to motion pictures. Each image is a screen shot or a reproduction of the current screen of a video display sent at a rate less than 24 frames per second to effectuate a still image or screen shot effect. Therefore, the second display may be used in the front section 8 of the vehicle without impinging upon existing government regulations prohibiting motion picture displays viewable by the driver and/or front seat passengers of the vehicle.

In one exemplary embodiment, the rear seat entertainment system 30 is configured to automatically switch from the media player control mode to a different mode once the media player is properly playing the subject film. In another embodiment, the second display 454 automatically updates with the screen image of the first display 452 as different selections are made throughout the media menu. In another exemplary embodiment, the second display 454 updates at a predetermined rate less than 24 frames per second. The automatic updates enable users to receive non-motion picture images in the front section 8 of the vehicle regarding current media player information.

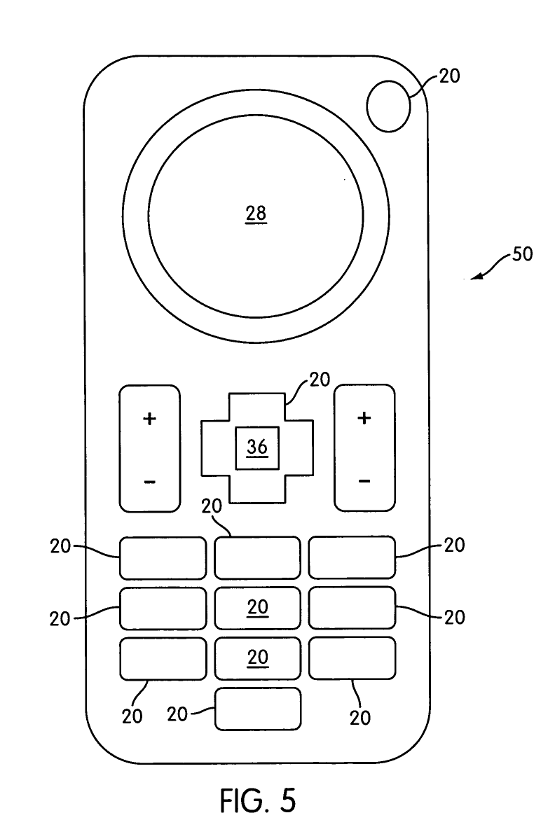

In one exemplary embodiment, a portable controller 50 (as shown in FIG. 5) is provided with the rear seat entertainment system 30. The controller 50 includes the second user input device and second display 28. FIG. 5 is a side view of an exemplary hand-held or portable controller 50 for a rear seat entertainment system 30. The controller 50 includes a keypad having entertainment control buttons or switches 20 for operating components of rear seat entertainment system 30. Control switches 20 may be configured to activate any of a number of functions, such as playing, rewinding, fast forwarding, stopping, and pausing a video or audio source. Additionally, switches may be provided for adjusting the volume and changing a channel, or any other appropriate functions for use with rear seat entertainment system 30. Controller 50 also includes a second display 28 for displaying information. An input selection key 36 is also included to select functions from a menu screen. Any type of control switches or knobs that may be configured for controlling rear seat entertainment system 30 or other features of vehicle 10 may be included in the controller 50 and the type and configurations of switches and knobs may be modified depending on design or functional considerations. The controller 50 is configured to operate simultaneously with other controls for the rear entertainment system 30. For example, the DVD player could include control keys (e.g., 36 as shown in FIG. 3) coupled to the housing unit through which the media player may be controlled in conjunction with controller 50. Additionally, any number of controllers can be provided to enable multiple passengers to control the media player simultaneously.

In one exemplary embodiment, the portable controller 50 controls a plurality of vehicle systems (e.g., HVAC, a personal navigation system—having a GPS receiver and/or geographic information database, personal digital assistant systems, or telecommunication devices). The controller may be, for example, a “smartphone” or a dedicated RSE or vehicle system controller. The user input device includes a switch configured to select one of the plurality of modes for the controller 50. In this way, the controller enables one control platform to be “moded” or selected at a given time. The mode may be selected from a visual setup menu shown on the second display. User prompts are provided on the user display for the appropriate selections and adjustments.

In one exemplary embodiment, the entertainment system 30 includes a wireless communication module configured to communicate with the second control circuit via a portable controller 50. The wireless communication module sends at least one of video data (e.g., screen shots, screen captures, still images, etc.) and entertainment system status data to the controller 50. In one embodiment, a media receiver is coupled to the portable controller 50 for accepting the signals from the wireless communication module. Bluetooth technology, configured to enable short-range communication between electronic devices, is utilized to enable the media device to communicate with the controller 50 wirelessly. Other wireless standards or technologies can be used with the entertainment system 30 such as IEEE 802.11 and other communication platforms.

In another exemplary embodiment, controller 50 is mountable at various locations throughout the vehicle. Each location may include a docking station. The portable controller is mountable upon any one of the docking stations. The docking station includes a mechanical fastener to secure the controller to the vehicle. In one exemplary embodiment, the docking station includes electrical wiring to support communication between the media player and the controller 50. Docking stations may be located on the vehicle instrument panel, center mounted console, rear view mirror, steering assembly and/or vehicle door assembly. In another exemplary embodiment, the docking station may include power connections to supply power to the controller 50. The controller 50 includes a rechargeable power storage device to supply power to the controller 50 when operating in wireless mode. In one embodiment, the docking station is connectable to any one of an instrument panel, center mounted console, rear view mirror, steering assembly, and vehicle door assembly.

In another exemplary embodiment, multiple user input devices may also be provided in the vehicle 10, and may include either identical or differing configurations. Particularly, in vehicles with extended rear sections 9, e.g., passenger vans and limousines, more than two interfaces may be provided to control the media player. Multiple media players may also be included.

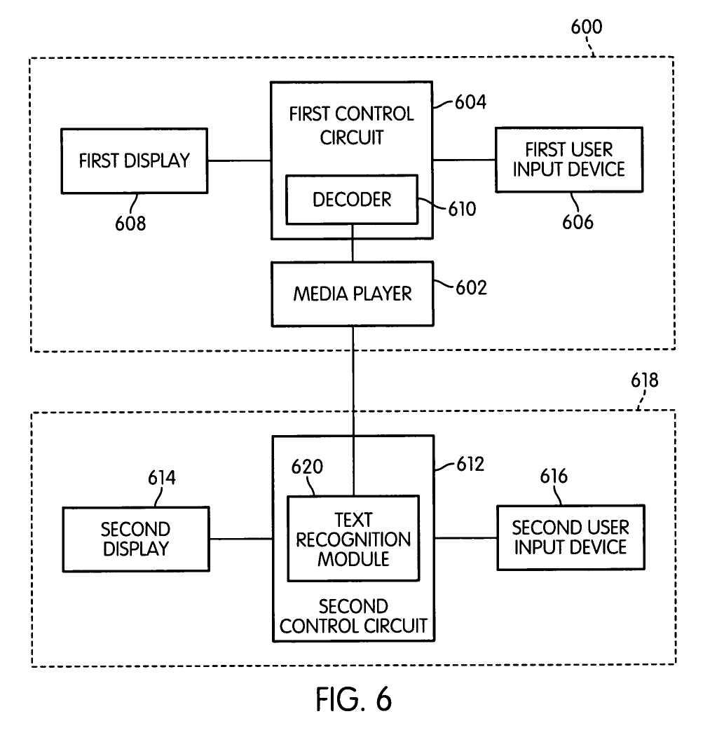

FIG. 6 is a schematic block diagram of electronic components of a rear seat entertainment system including a driver or front user input device in accordance with an embodiment. A first location 600 of the vehicle includes a media player 602, a media player control circuit 604, a user input device 606 and a first video display 608. Video display 608 is positioned in the vehicle so that is may be viewed by occupants in a rear section of the vehicle and not viewed by occupants in a front section of the vehicle. Media player 602 may be, for example, DVD player configured to read and playback video and audio content programmed onto a medium such as a digital video disc (DVD) or compact disc (CD). Media player 602 reads, for example, the DVD, and generates a data or transport stream. Media player control circuit 604 is coupled to user input device 606, media player 602 and video display 608. As discussed above, user input device 606 is configured to receive commands from a user for a variety of functions such as playing, rewinding, fast forwarding, stopping and pausing media player 602. Video display 606 is configured to display data (e.g., video data, text data, etc.) to occupants of the vehicle.

Media player control circuit 604 may include various types of control circuitry, digital and/or analog, and may include a microprocessor, microcontroller, application specific integrated circuit (ASIC), or other digital and/or analog circuitry configured to perform various input/output, control, analysis and other functions to be described herein. Media player control circuit 604 is configured to, for example, receive inputs from user input device 606, provide instructions or commands (e.g., a “PLAY” instructions) to media player 602, receive a data stream from media player 512 and provide video signals and other data from media player 602 to video display 608. Accordingly, media player control circuit 604 includes an MPEG decoder 610 (or other appropriate decoder) to decode the data stream, e.g. video signals or other data, provided by media player 602 from, for example, a DVD.

When a user provides a command via user input device 606 to “PLAY” a digital media source, such as a DVD, in media player 602, an instruction to play the DVD is provided to media player 602 by media player control circuit 604. In addition to video signals, a DVD, or other digital media, may include a default menu that is displayed on video display 608 before playing the video content. For example, a default menu may include items such as “PLAY”, “SCENE SELECTION”, “BONUS MATERIALS”, “OTHER MOVIE TRAILERS” and “SET UP.” Once displayed, the media player awaits a selection input from a user to select one of the menu items. MPEG decoder 610 is used to decode the menu data and video signals in the data stream from media player 602. MPEG decoder may use methods generally known in the art to decode the data stream. Media player control circuit 604 is configured to provide the decoded data (e.g., decoded menu data and decoded video data) to video display 608.

A driver interface control circuit 612 is coupled to a second display 614 and second user input device 616. These components are positioned in a second location 618 in the vehicle, preferably a location that is viewable by an occupant in the front section 8 of the vehicle (e.g., a driver or front seat passenger). Front display 614 may be mounted in or coupled to, for example, an interior roof or headliner, an instrument panel, a dashboard, hand held controller 50 or other suitable location in a front section of a vehicle. Driver interface control circuit 612 may include various types of control circuitry, digital and/or analog, and may include a microprocessor, microcontroller, application specific integrated circuit (ASIC), or other digital and/or analog circuitry configured to perform various input/output, control, analysis and other functions to be described herein.

In another exemplary embodiment, the rear seat entertainment system includes a text recognition module or capability (e.g., software and/or hardware) 620 configured to process textual menu data received from the media player 602 and display the information on the second display 614. Text recognition module 620 is configured to process the decoded menu data received from the media player control circuit 604, to generate textual menu data (e.g., ASCII data) from the decoded menu data and to provide the textual menu data to a driver interface control circuit 612. Text recognition module 620 may process the decoded menu data using optical character recognition (OCR) techniques or digital image recognition techniques to read the menu text. Text recognition module 620 may include software and/or hardware for OCR or digital image recognition techniques generally known in the art. Textual menu data, e.g., ASCII data, is generated and transmitted to the driver interface control circuit 612. Driver interface control circuit 612 may communicate with text recognition module 620 and media player control circuit 604 via a vehicle bus. The second control circuit also includes a decoder 622 to decode information received from the media player 602. MPEG decoder 622 is used to decode the menu data and video signals in the data stream from media player 602. MPEG decoder may use methods generally known in the art to decode the data stream. Media player control circuit 604 is configured to provide the decoded data (e.g., decoded menu data and decoded video data) to video display 614.

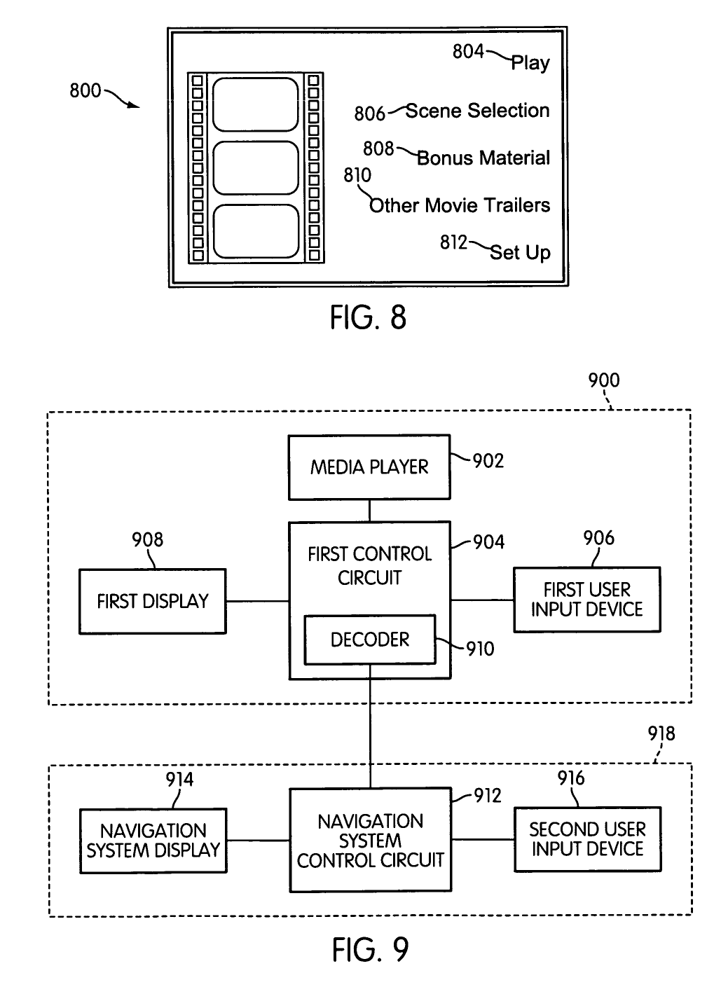

Driver interface control circuit 612 is configured to receive the textual menu data from the text recognition module 620, to provide the textual menu data to the front display 614, to provide audio menu data (if appropriate) to speakers, to receive user inputs from user input device 616 (e.g., a menu selection) and to provide commands to media player-control circuit 604 regarding, for example, a menu selection. The textual menu data may be provided to front display 614 to be viewed by an occupant of the vehicle in the front section 8. FIG. 8 is an exemplary textual menu display 800 in accordance with an embodiment. Textual menu display 800 may be provided on front display 614 (shown in FIG. 6). Textual menu display 800 includes various items including PLAY 804, SCENE SELECTION 806, BONUS MATERIALS 808, OTHER MOVIE TRAILERS 810, and SET UP 812. A user in the front section 8 of the vehicle may select a menu item via user input device 616. Driver interface control circuit 612 may provide commands (e.g., a menu selection) to media player control circuit 604 based on user input received via user interface 616.

In another exemplary embodiment, voice recognition software is provided. A media player 702, control circuit 704, user input device 706, first display 708 and decoder 710 are provided at a first location 700 in the vehicle 10. At a second location 718 in the vehicle, a driver control circuit 712, second display 714, second user input device 716 and text recognition module 720 are provided. Driver interface control circuit 712 is configured to receive the menu data to provide audio menu data to speakers and to receive audio user inputs (e.g., a menu selection) and to provide commands to media player control circuit 704 regarding, for example, a menu selection. A microphone is incorporated in the second user input device 716. The microphone is connected to the second control circuit which includes a voice recognition module 720 to process user commands and transmit control signals to the media control circuit 704. In one arrangement the second user input device communicates wirelessly with the media control circuit 704. This enables passengers to use conversational language to control the rear seat entertainment system 30 with speech commands.

FIG. 9 is a schematic block diagram of electronic components of a rear seat entertainment system 30 including a driver or front interface in accordance with an alternative embodiment. The vehicle includes a navigation system 918 that comprises a navigation system display 914, navigation system control circuit 912 and a user interface 916 mountable in a front section of the vehicle. Navigation display 914 is configured to display information including video signals. A data stream from media player 902, including menu data and video data, is decoded by MPEG decoder 910 and then provided to navigation system control circuit 912. A media player 902, control circuit 904, user interface 906, first display 908 and decoder 910 are provided at a first location 900 in the vehicle 10. Media player control circuit 904 and navigation system control circuit 912 may communicate via a vehicle bus. The decoded menu data is then sent to the navigation system display 914 to be displayed to a user. A user may use user interface 916 to provide input regarding the displayed menu items, e.g., selecting a menu item. Once the video signals (e.g., a movie) begin to play, the video feed to the navigation screen display 914 is ended.

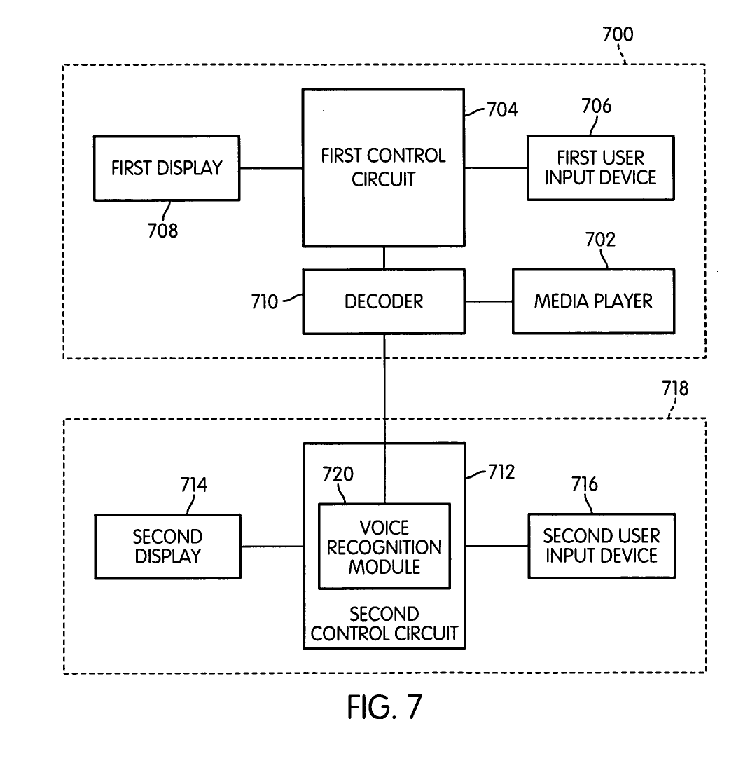

A method for controlling a rear seat entertainment system from a front section of the vehicle is also provided. The media player and a first display are located in a rear section of the vehicle (as shown in FIGS. 6 and 7). The method involves providing video signals, menu information or media player mode data to a first display viewable in a rear section of the vehicle; transmitting the at least one of screen shot data, menu information or media player mode data to a portable electronic device locatable in the front section of the vehicle. The transmitting step is performed wireless. The method also includes receiving the transmitted data at the portable electronic device.

While the exemplary embodiments illustrated in the FIGS. and described above are presently preferred, it should be understood that these embodiments are offered by way of example only. Accordingly, the present invention is not limited to a particular embodiment, but extends to various modifications that nevertheless fall within the scope of the appended claims. The order or sequence of any process or method steps may be varied or re-sequenced according to alternative embodiments.

What is claimed is:

1. A vehicle entertainment system, comprising:
a media player configured to read data from a medium, the data comprising video signals;
a first display configured to display the video signals to a rear section of the vehicle;
a first control circuit coupled to the media player comprising a decoder module configured to decode data received from the media player and to transmit at least one of media player mode data, menu information and video signals to the first display;
a second display configured to display the video signals to a front section of the vehicle; and
a second control circuit coupled to the second display and configured to receive and transmit at least one of media player mode data, menu information and screen shots of the video signals to the second display.

2. The vehicle entertainment system of claim 1, wherein the first control circuit is configured to transmit the at least one of media player mode data and screen shots wirelessly to the second display.

3. The vehicle entertainment system of claim 1, wherein the second display is coupled to a portable device.

4. The vehicle entertainment system of claim 1, further comprising a user input device coupled to the portable device configured to send a control signal to the media player to control the media player mode of operation upon actuation.

5. The vehicle entertainment system of claim 3, wherein the portable device is a personal navigation device.

6. The vehicle entertainment system of claim 3, wherein the portable device is configured to accept video signals, media player mode data and media data, and further configured to transfer the video signals, media player mode data and media data to the second interface.

7. The vehicle entertainment system of claim 1, wherein the second display is coupled to the center stack console of the vehicle.

8. The vehicle entertainment system of claim 1, wherein the first control circuit is configured to receive the decoded data to identify menu data and to generate textual menu data from the identified menu data.

9. The vehicle entertainment system of claim 1, wherein the media player is a DVD player.

10. The vehicle entertainment system of claim 1, wherein the first control circuit is configured to decode into an MPEG format.

11. The vehicle entertainment system of claim 1, wherein the menu data is identifiable from the decoded data using a digital image recognition technique.

12. The vehicle entertainment system of claim 1, wherein the menu data is identifiable from the decoded data using optical character recognition software.

13. The vehicle entertainment system of claim 1, wherein the second interface comprises a user input device configured to send a control signal to the media player to control the media player mode of operation upon actuation.

14. A vehicle entertainment system, comprising:
a media player configured to read data from a medium, the data comprising video signals;
a first display configured to display the video signals to a rear section of the vehicle;
a first control circuit coupled to the media player comprising a decoder module configured to decode data received from the media player and to transmit at least one of media player mode data, menu information and video signals to the first display;
a second display configured to display the video signals to a front section of the vehicle;
a second control circuit coupled to the second display and configured to receive and transmit at least one of media player mode data, menu information and screen shots of the video signals to the second display; and
a user input device coupled to the second control circuit;
wherein the user input device is a microphone and wherein the second control circuit comprises voice recognition software, configured to send a control signal to the media player to control the media player mode of operation.

15. The vehicle entertainment system of claim 14, wherein the first control circuit is configured to transmit the at least one of media player mode data and screen shots wirelessly to the second display.

16. The vehicle entertainment system of claim 14, wherein the second display is coupled to a portable device, and wherein the system comprises a second user input device coupled to the portable device configured to send a control signal to the media player to control the media player mode of operation upon actuation.

17. The vehicle entertainment system of claim 16, wherein the portable device is configured to accept video signals, media player mode data and media data, and further configured to transfer the video signals, media player mode data and media data to the second interface.

18. The vehicle entertainment system of claim 14, wherein the second display is coupled to the center stack console of the vehicle.

19. The vehicle entertainment system of claim 14, wherein the first control circuit is configured to receive the decoded data to identify menu data and to generate textual menu data from the identified menu data.

20. The vehicle entertainment system of claim 14, wherein the media player is a DVD player.

21. The vehicle entertainment system of claim 14, wherein the first control circuit is configured to decode into an MPEG format.

22. The vehicle entertainment system of claim 14, wherein the menu data is identifiable from the decoded data using a digital image recognition technique.

23. The vehicle entertainment system of claim 14, wherein the menu data is identifiable from the decoded data using optical character recognition software.

24. A method for providing a front seat passenger of a vehicle with an interface to a rear seat entertainment system, comprising:
providing at least one of video signals, menu information and media player mode data to a first display viewable in a rear section of the vehicle;
transmitting the at least one of screen shot data, menu information and media player mode data to a portable electronic device locatable in the front section of the vehicle, wherein the transmitting step is performed wireless; and
receiving the transmitted data at the portable electronic device.

25. The method of claim 24, further comprising:
receiving a user input provided through the portable electronic device;
transmitting the user input to the rear seat entertainment system; and
controlling the rear seat entertainment system based on the user input.

26. The method of claim 24, further comprising:
projecting audible menu data and/or media player mode data from the vehicle entertainment system.
